(19) United States
(12) Patent Application Publication
(10) Pub. No.: US 2024/0245976 A1
(43) Pub. Date: Jul. 25, 2024

(54) PICKLEBALL SCOREKEEPING DEVICE, METHOD AND SYSTEM

(71) Applicants: Richard K. Cohen, Ann Arbor, MI (US); John G. Posa, Savannah, GA (US)

(72) Inventors: Richard K. Cohen, Ann Arbor, MI (US); John G. Posa, Savannah, GA (US)

(21) Appl. No.: 18/121,123

(22) Filed: Mar. 14, 2023

Related U.S. Application Data
(60) Provisional application No. 63/440,071, filed on Jan. 19, 2023.

(51) Int. Cl. A63B 71/06; G06F 3/14; G10L 15/22

(52) U.S. Cl. CPC A63B 71/0669; G06F 3/1454; G10L 15/22; A63B 2071/0663; A63B 2225/50; G06F 3/02

(57) ABSTRACT

A pickleball scorekeeping system includes wearable devices that use speech recognition to interpret and display the scores called out in the game. Each device is pairable with other devices, such that the called-out score is distributed and displayed to other players using wireless communications circuitry. The scores on each device are displayed in order as the score of the serving team and the score of the receiving team so that each player sees the score from their perspective. Each device is also capable of recognizing and indicating the serve number. The sequence of numbers is displayed in response to a voice command or activation of the user control. A system may include a sideline unit operative to wirelessly receive and display player and score information to spectators. The sideline unit may also serve as a base station for device charging, WiFi communications, and/or Internet distribution of scores and other functions.

### REFERENCE TO RELATED APPLICATIONS

This application claims priority to and the benefit of U.S. Provisional Patent Application Ser. No. 63/440,071, filed Jan. 19, 2023, the entire content of which is incorporated herein by reference.

### FIELD OF THE INVENTION

The present invention relates to pickleball and, more particularly, to a wearable device, method and system for keeping track of the score in pickleball.

### BACKGROUND OF THE INVENTION

Pickleball has become widely popular. There are numerous resources available to learn the rules of the game.

In singles games, the server calls out two numbers before each serve: the server's score followed by the receiver's score.

With respect to scoring, in doubles, you call out 3 numbers before each serve: your team's score, the other team's score, the server number.

Remembering the score in pickleball can be challenging, however, particularly after a long rally. While there are devices for keeping score in pickleball, including “apps” and manual counters, existing solutions tend to be limited in functionality.

### SUMMARY OF THE INVENTION

This invention improves upon pickleball scorekeeping by providing a wearable, battery-operated device that uses speech recognition to receive and display the score called out by the server in the game. In the preferred embodiment, four devices are used is doubles pickleball. However, the invention accommodates singles play as well as individual use.

Each device includes an electronic controller in operative communication with a microphone, a display, and wireless communications circuitry. The controller is operative to recognize a sequence of at least two numbers spoken into the microphone and display the two numbers on the display in an order corresponding to the score of a pickleball server and the score of a pickleball receiver, respectively. Each device is pairable with other devices, such that the called-out score is distributed using the wireless communications circuitry for display on the display of the other device or devices.

To avoid confusion, the scores on each device are displayed in order as the score of the serving team and the score of the receiving team. In other words, the scores called out by the server are juxtaposed or reversed when displayed on the device of an opponent so that each player sees the score from “their perspective.” Also in preferred embodiments, each device is further capable of recognizing a third number, either a “1” or a “2” corresponding to the number of serves taken by a team in doubles pickleball. The third number is also indicated on paired devices. Each device may optionally indicate which side served the ball.

Each device may include a pushbutton or other user control, with the controller being operative to recognize the sequence of numbers spoken into the microphone through a voice command or activation of the user control. A system according to the invention may include a sideline unit operative to wirelessly receive and display at least the score to spectators. The sideline unit may also serve as a base station for device charging, WiFi communications, Internet distribution of scores and other functions.

Apparatus for keeping score in doubles pickleball, comprises four wearable, battery-operated devices, with two of the devices being worn by respective players on a first team, and two of the devices being worn by respective players on a second team. Each device includes a controller in operative communication with a microphone, a display, and wireless communications circuitry to perform the following functions:
(a) recognize a sequence of three numbers spoken into the microphone by a pickleball server,
(b) wirelessly transmit the sequence to the other players, and
(c) indicate the sequence of three numbers on the display of each device, with the first number corresponding to the score of the team serving the ball, the second number corresponding to the score of the team receiving the ball, and the third number being a “1” or a “2” corresponding to the serve number of the team serving the ball. The third number is displayed on each device as an indicator light or as a numerical digit.

Each device includes a pushbutton or other user control, and the controller in each device is operative to recognize the sequence of three numbers as a voice command or activation of the user control. The devices are provided in a paired condition or user pairable, such that the devices only communicate with each other without interference from other devices.

Thus, in doubles pickleball, when one side receives the ball from the other side to serve (i.e., after a “sideout”), the server looks at the display, presses the pushbutton, and calls out the scores as displayed, but calls out a serve number as a “1” instead of the displayed “2,” since it will now be that team's first serve. If that server scores a point or keeps scoring, they refer to the display, press the button, and call out the score with an increased first number, followed by the score for the receiving side and server number (“1”) as currently displayed. When that server's partner receives the ball to serve after a fault, he/she presses the button and calls out the score numbers as displayed, but calls out a “2” instead of the displayed “1,” as this would be the second serve for that side.

The above process continues until the final score is reached. Note that the invention operates correctly with any type of fault, and if they score is called incorrectly or misunderstood, it may simply be called again, and the previous call-out will be “overwritten.” The invention also accommodates the starting score in double pickleball (0 0 2) by simply calling out “zero zero two.” A device may be reset in other ways such as holding down the button 106, or using a command such as “START,” in which case all devices will display 0 0 2.

A system may include a sideline unit operative to wirelessly receive and display the scores of two teams. The sideline unit may also serve as a base station for device charging, WiFi communications, Internet distribution of scores and other functions.

### BRIEF DESCRIPTION OF THE DRAWINGS

FIG. 1A is a drawing of a wearable device constructed in accordance with the invention;

FIG. 1B depicts an alternative embodiment of the invention wherein the display also has indicators showing which side is serving the ball;

FIG. 1C depicts a different alternative embodiment of the invention wherein the display uses two serve number indicators that also show which side is serving;

FIG. 1D illustrates a further alternative embodiment wherein the score and serve numbers are in a row;

FIG. 2 depicts the use of two devices worn by opposing teams;

FIG. 3A shows the displays of four devices in communication after the server wearing one of the devices has called the score as “two one one”;

FIG. 3B shows how the displays of four devices appear, assuming the server wearing device in FIG. 3A has scored a point and called out “three one one”;

FIG. 3C shows how the displays of four devices appear, assuming the server in FIG. 3B faults, and his/her partner calls out “three one two” prior to serving;

FIG. 3D shows how the displays of four devices appear, assuming the server in FIG. 3C defaults, such that a new server calls out “one three one”;

FIG. 3E shows how the displays of four devices appear, assuming the server in FIG. 3D scores a point, calling out “two three one,” prior to serving the ball;

FIG. 4 is a block diagram of electronics applicable to the invention; and

FIG. 5 is a block diagram of a sideline unit and/or base station.

### DETAILED DESCRIPTION OF THE INVENTION

Pickleball score (in doubles) is called by the server as three numbers: (1) the score of the serving side; (2) the score of the receiving side; and (3) which serve it is (1 or 2). See, for example, https://www.youtube.com/watch?v=RoheCHp6IDw. The score usually goes up to 11, though some play to 15 and tournaments can go to 21. Since the winner must win by 2 points, in some cases the score can even go higher.

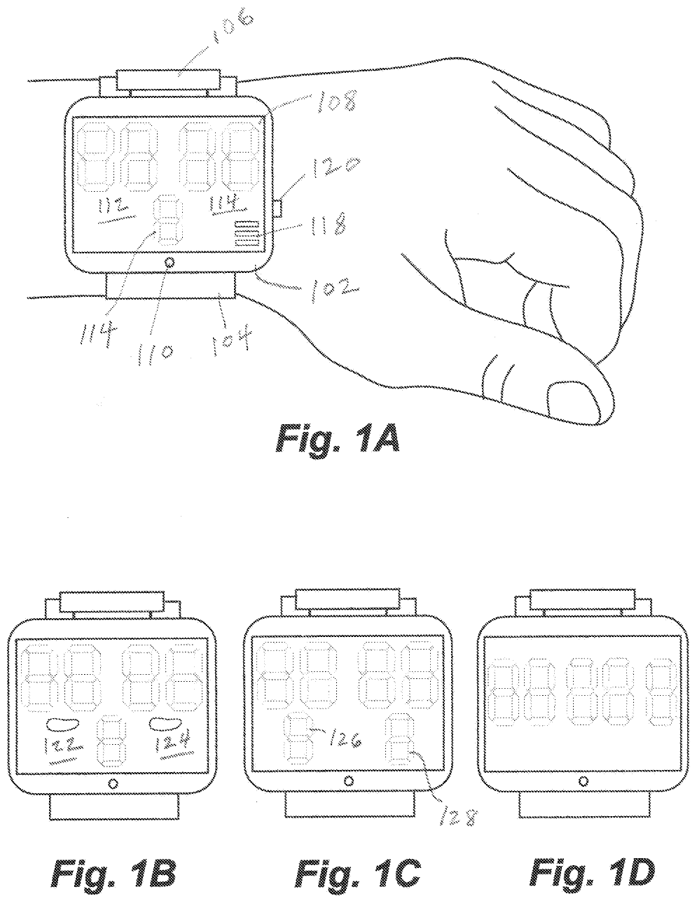

A preferred embodiment of a device according to the invention is illustrated in FIG. 1A. The device including a housing 102 that is user-wearable as a watch-like device with a strap 104, though wearing as a brooch, etc., is also possible. The device also includes a display 108 and a microphone 110.

The display 108 includes a first two-digit field 112 indicating the score of the serving side; a second two-digit field 114 indicating the score of the serving side; and a single digit 116 indicating the number of the serve. The device may also include a battery indicator 118 and an ON-OFF switch 120.

Each device further includes a speech/voice recognition electronics in communication with the microphone, and wireless communications circuitry enabling each device to send and receive the called score from other devices. FIG. 1B depicts an alternative embodiment of the invention wherein the display also has indicators 122, 124 showing which side is serving. FIG. 1C depicts a different alternative embodiment of the invention wherein the display uses two serve number indicators 126, 128 that also show which side is serving, and FIG. 1D illustrates a further alternative embodiment wherein the score and serve numbers are in a row, and though not shown, serving-side indicators 122, 124 may also be used.

The description herein will focus on use of the device in doubles pickleball, though any number of players may use the device in singles or doubles pickleball. Even one player may use the device for personal scorekeeping, with other perhaps relying on that person to let them know game status.

In doubles pickleball, the device may be worn by all for players. As is typical, before each serve the server calls the score as three numbers: the score of the serving side, the score of the receiving side, and the serve number (a 1 or a 2). Using the invention, the called score is received by the device and transmitted to other players for display on their devices.

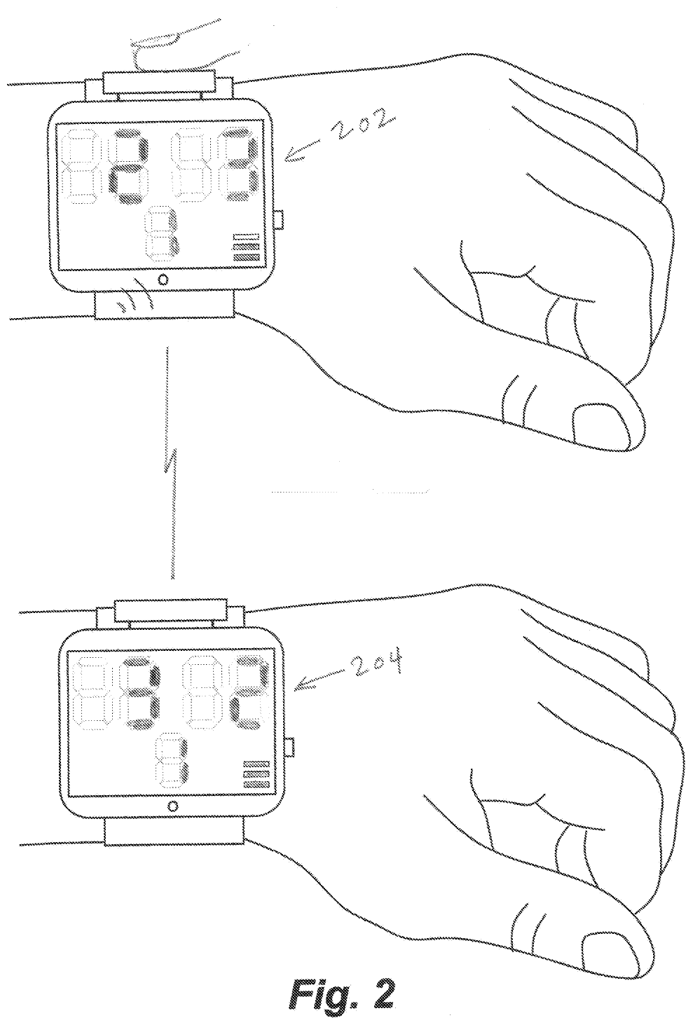

FIG. 2 is an example of use of two devices by opposing teams. Using device 202, the server presses button 106 and calls the score as “2 3 1,” which means that the serving side has two points, the receiving side has three points, and this is the first serve for that server. This call is transmitted wirelessly to device 204, which displays the score to an opposing player. In accordance with the invention, the first two numbers are transposed, such that the other player sees the score from their perspective; namely, 3 to 2. The user of device 204 also sees that it is the first serve, albeit for the other side.

Thus, in accordance with the invention, in doubles pickleball, when one side receives the ball from the other side to serve (i.e., after a “sideout”), the server looks at the display and calls out the scores as displayed, but calls out a serve number “1” instead of the displayed “2,” since it will now be that servers first serve. If that server scores a point or keeps scoring, they refer to the display, press the button and call out the score with an increased first number, followed by the score for the receiving side and server number (“1”) as displayed. When that server's partner receives the ball to serve after a fault, he/she calls out the score numbers as displayed, but calls out a “2” instead of the displayed “1,” as this would be the second serve for that side.

The above process continues until the final score is reached. Note that the invention operates correctly with any type of fault, and if they score is called incorrectly or misunderstood, it may simply be called again, and the previous call-out will be “overwritten.” The invention also accommodates the starting score in double pickleball (0 0 2) by simply calling out “zero zero two.” A device may be reset in other ways such as holding down the button 106, or using a command such as “START,” in which case all devices will display 0 0 2.

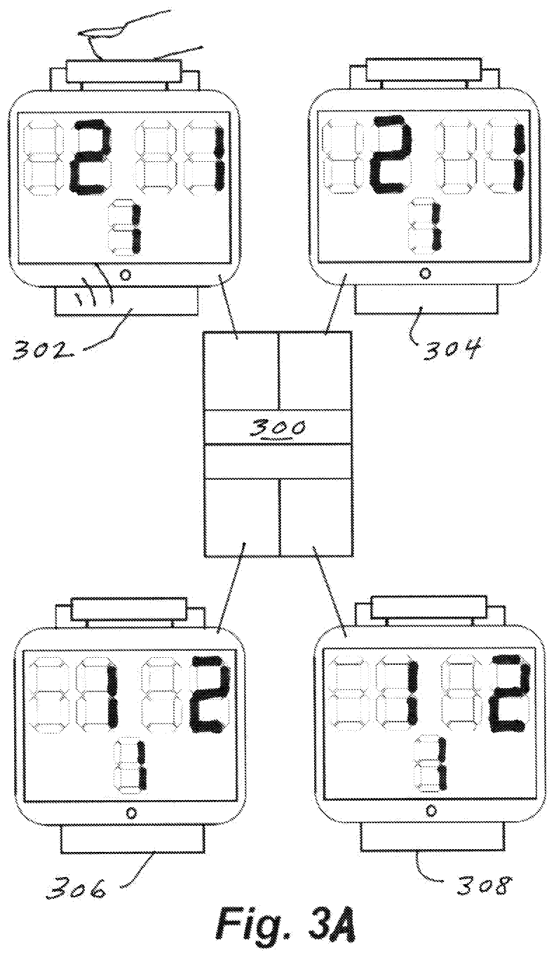

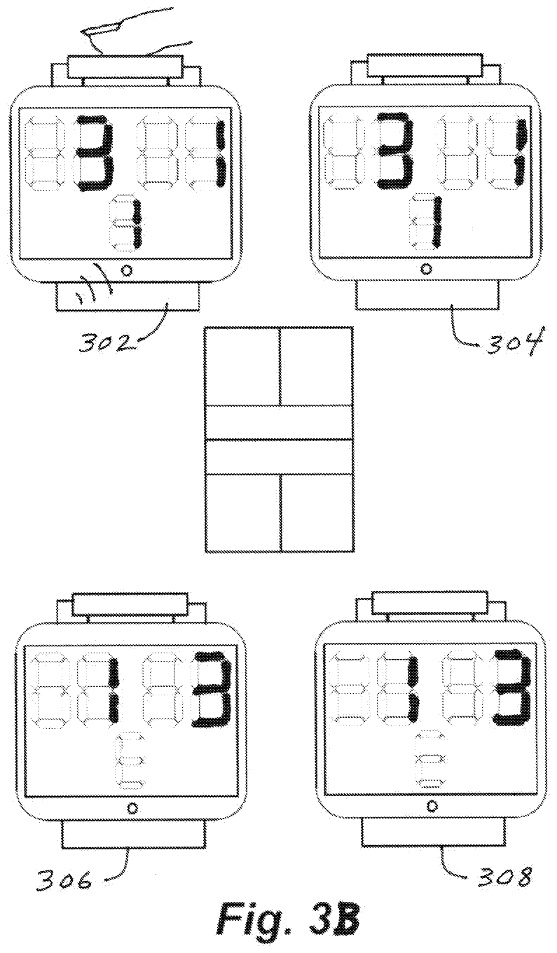

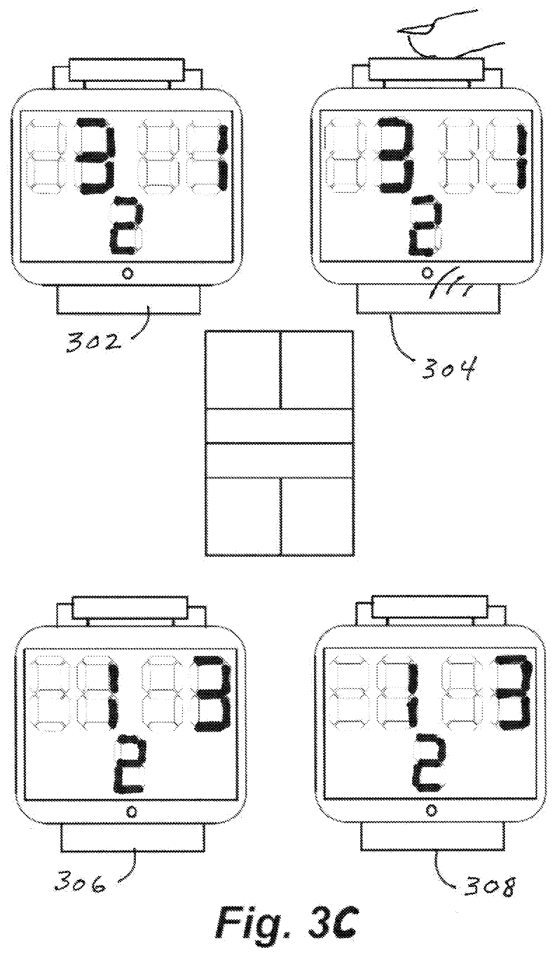

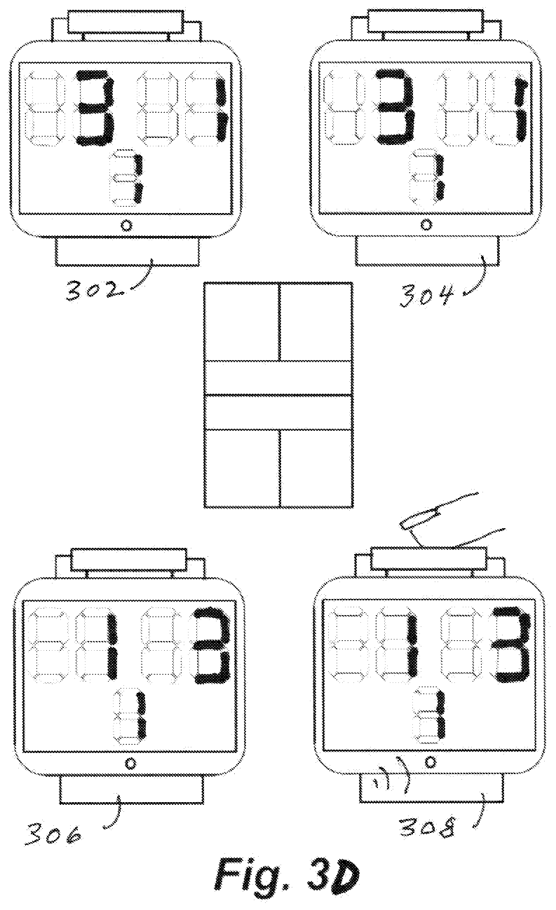

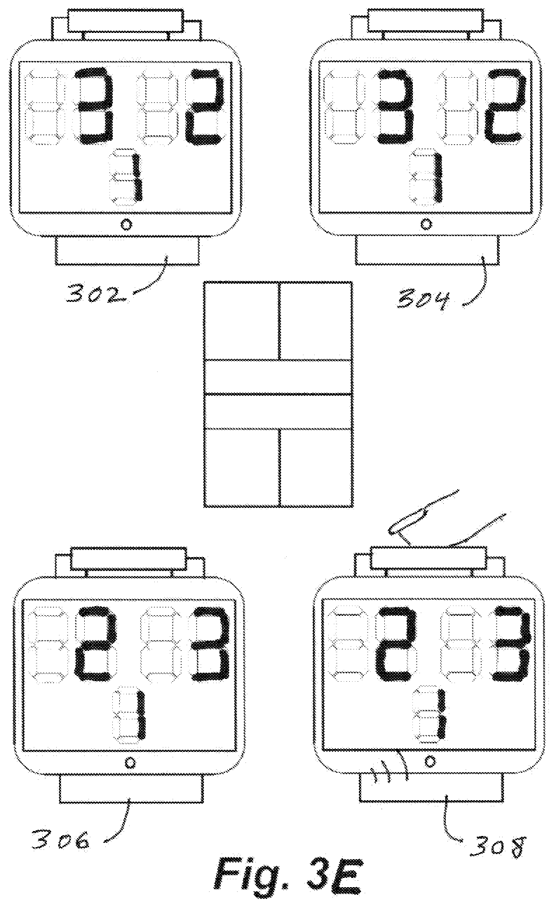

A possible sequence is illustrated in FIG. 3 with respect to players using court 300. In FIG. 3A, the server wearing device 302 has called out “two one one,” meaning that the serving team is in the lead by a score of 2 to 1 and this is the first serve for the serving team. The same display appears on the device 304 of the server's partner, but with respect to devices 306, 308 for the opposing team the scores are reversed though serve number remains the same.

Assuming the server wearing device 302 in FIG. 3A scores a point, the same server now calls out “three one one,” as shown in FIG. 3B, meaning that the serving team is now in the lead by a score of 3 to 1 and this is still the first serve for the serving team. The same display is reflected on the device 304 of the server's partner, but with respect to devices 306, 308 for the opposing team the scores are again reversed with the serve number remaining the same.

Now assuming the server in FIG. 3B faults, his/her partner gets to serve, and calls out “three one two” using device 304 shown in FIG. 3C, indicating that the serving team is still in the lead by a score of 3 to 1, but this is now the second serve for the serving team. The server wearing device 304 in FIG. 3C defaults, such that the user wearing device 308 now serves, calling out “one three one,” as shown in FIG. 3D, meaning that the opposing team is now the serving team which is losing by a score of 1 to 3 and this is still the first serve for that team. The server using device 308 in FIG. 3D scores a point, calling out “two three one,” as shown in FIG. 3E, and so on.

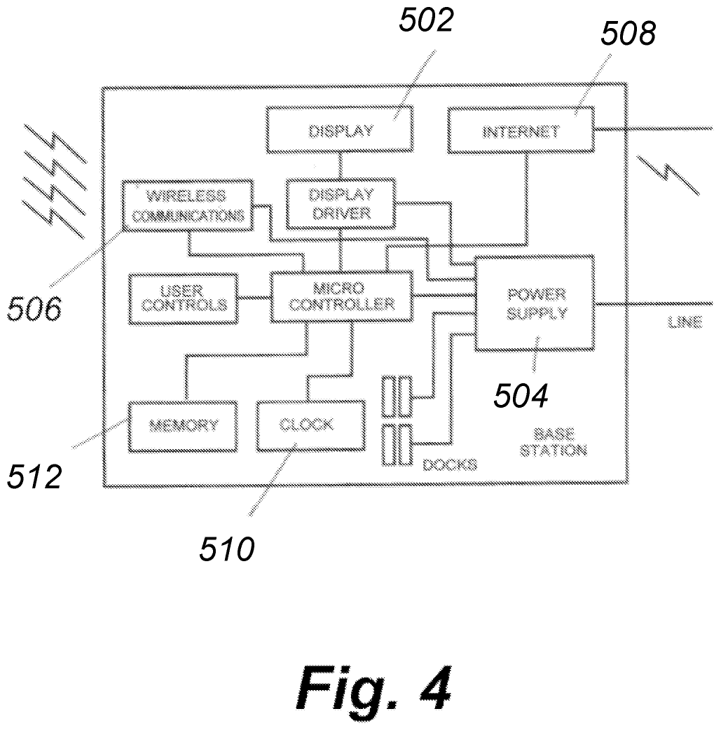

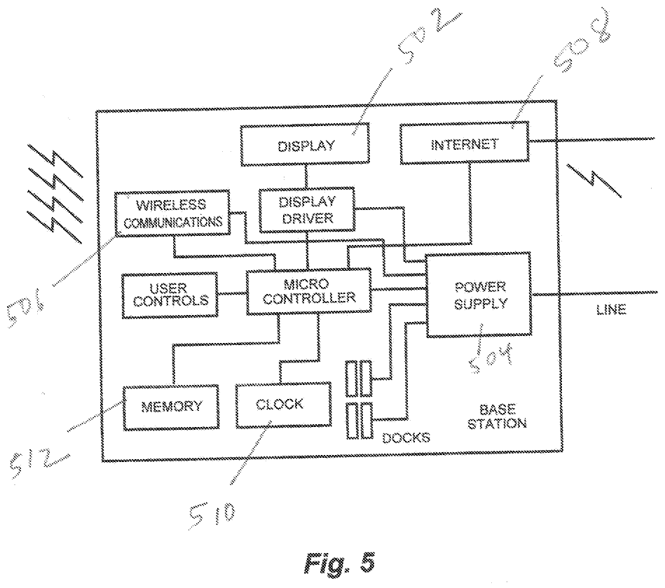

FIG. 4 is a block diagram of electronics applicable to the invention. Each device is powered by a battery, preferably rechargeable via jack 404, which may use a standard interface such as USB or the like. An ON/OFF switch (not shown in FIG. 4) may be used to disconnect internal components when not in use. Those of skill in the art will appreciate that while separate blocks are shown in FIG. 4, some or preferably all of the functions may be integrated into a single microcontroller or application-specific integrated circuit (ASIC).

Microphone 110 feeds an analog-to-digital (A/D) converter 408, and speech/voice recognition may be performed by a dedicated chip or microcontroller 406. The user control is preferably implemented as a momentary contact pushbutton. Memory 416 may be a random-access memory (RAM) to store temporary information and/or a non-volatile memory to store program instructions and/or storing information without being lost during battery power interruptions.

The device should be capable of performing speaker-independent speech, but this is made easier by a limited vocabulary. In particular, the device only needs to recognize numbers up to 29, and perhaps a few words as described here. Such recognition is well within the capability of inexpensive circuits of the type now used in hand-held remote controls, for example. In causal games, the score only goes up to 11 or 15, win by 2.

Display 410 can be of any technology, preferably one that can be seen in bright sunlight such as LCD, LED or OLED. Separate devices may be used for the numerical displays, or a single panel may be used for all the numbers. The display(s) may be in black and white, and 7-segment or dot-matrix technologies may be used. Indicator lights are preferably implemented with LEDs.

The display(s) may remain ON during play, or the display may turn OFF automatically after a predetermined period of time to conserve battery power. Another option is that the user control 414 (i.e., pushbutton) may be pushed (at any time) without speaking to see the display. The user control may be eliminated altogether through the use of voice commands such as “SCORE” or “PICKLE” preceding numerical inputs. Other functions may also use voice commands such as “RESET,” “PAIR,” “SINGLES,” “DOUBLES,” and so forth.

The wireless communications circuitry 412 may use any appropriate two-way technology, including one-to-one (i.e., “paired” Bluetooth), WiFi, or many-to-many protocols, including mesh Bluetooth, ZigBee or other mesh network protocols. In preferred embodiments, all devices communicate with one another using a many-many protocol, such that when a score is called, the displays on all device reflect the current score.

A system may be provided with two or four pre-paired devices, or the devices may be user-paired through voice commands, activation of user control(s), or automatically through proximity or touching of devices, with or without activation of user control(s). A portion of each device may have an area on the back, for example, to imprint or otherwise receive identifying indicia to indicate pairing. For example, four devices may be factory or user-labeled as X-A, X-A, X-B, X-B, indicating that all devices belong to set “X,” with the “A” devices belonging to one side, and the “B” devices belonging to the other side.

In singles pickleball the third serve number (1 or 2) is not required. Devices according to the invention may be used in singles play by only reciting two numbers, with or without activation of a user control, with the device “assuming” that it is a singles game. Alternatively, a SINGLES/DOUBLE switch 418 may be provided wherein, in the SINGLES setting, the third server number is not “expected.”

As an alternative to many-many networking, the devices may communicate with a base station that may receive the score from one player and transmit it to the others. The base station may also be used to dock the devices for recharging. As a further option, as shown in FIG. 5, the base station may act as a stationary “sideline unit” providing the scores or other information on a larger display 502 for spectator viewing.

The unit would be controlled by a processor powered by a battery or power supply 504 connected to line voltage. The power supply may also feed docks to recharge the user-worn devices. The wireless communications interface 506 may use any appropriate technology to communicate with the wearable devices. The base station/sideline unit may also include WiFi, cellular communications or a wired Internet connection to act as a router, to accessing cloud-based processing, or to share game scores, statistics, etc., to other teams or remote sites. Memory 512 may be used to store multiple game outcomes, statistics, etc. The base unit may also include a clock 510 for score time-stamping and/or actual time-of-day display.

1. Pickleball scorekeeping apparatus, comprising:
a battery-operated device adapted to be worn by a pickleball player, the device including a controller in operative communication with a microphone, a display, and wireless communications circuitry;
wherein the controller is operative to recognize and display a sequence of at least two numbers spoken into the microphone by a pickleball player using the device;
wherein the device is pairable with another device used by a different player, such that the device is further operative to transmit the two recognized numbers to the paired device using the wireless communications circuitry for display on the display of the paired device; and
wherein the device and paired device both display the two recognized numbers in an order corresponding to the score of a pickleball server or serving team, and the score of a pickleball receiver or receiving team.

2. The apparatus of claim 1, wherein the device is further operative to:
recognize a third number spoken into the microphone, the third number being either a “1” or a “2” corresponding to the number of serves taken by a server in doubles pickleball;
wirelessly transmit the third number to the paired device; and
indicate the third number as an indicator light or a numerical digit on the device and the paired device.

3. The apparatus of claim 1, wherein the device is further operative to indicate which side is serving the ball on the display of the device and the paired device.

4. The apparatus of claim 1, further including pushbutton or other user control; and
wherein the controller is operative to recognize the sequence of numbers spoken into the microphone through a voice command or upon activation of the user control.

5. The apparatus of claim 1, further including a sideline unit operative to wirelessly receive and display the score to players or spectators.

6. Apparatus for keeping score in pickleball, comprising:
a plurality of battery-operated devices;
wherein at least one of the devices is adapted to be worn by a pickleball server, and at least one of the devices is adapted to be worn by a pickleball receiver;
each device including a controller in operative communication with a microphone, a display, and wireless communications circuitry;
wherein the device worn by the pickleball server is operative to perform the following functions:
(a) recognize a sequence of first and second numbers spoken into the microphone by the pickleball server,
(b) wirelessly transmit the sequence of the numbers to devices worn by other players, and
(c) indicate the sequence of spoken numbers on the display, with the first number corresponding to the score of the side serving the ball, and the second number corresponding to the score of the side receiving the ball; and
wherein the devices worn by the other players are operative to perform the following functions:
(d) wirelessly receive the sequence of numbers spoken by the pickleball server, and
(e) display the sequence of numbers, with the first number corresponding to the score of the side serving the ball the second number corresponding to the score of the side receiving the ball.

7. The apparatus of claim 6, wherein the controller in each device is further operative to recognize a third number corresponding to the number of serves made by a serving team and display the third number on each device, either as an indicator light or as a numerical digit.

8. The apparatus of claim 6, wherein the controller is further operative to cause each device to indicate which side is serving the ball.

9. The apparatus of claim 6, wherein each device includes a pushbutton or other user control; and
the controller is operative to recognize the sequence of numbers spoken into the microphone through a voice command or upon activation of the user control.

10. The apparatus of claim 6, wherein the devices are pairable such that the devices only communicate with each other.

11. The apparatus of claim 6, wherein the devices are provided in a paired condition or user pairable such that the devices only communicate with each other.

12. The apparatus of claim 6, further including a sideline unit operative to wirelessly receive and display the score.

13. Apparatus for keeping score in doubles pickleball, comprising:
four battery-operated devices;
wherein two of the devices are worn by respective players on a first pickleball team, and two of the devices are worn by respective players on a second pickleball team;
each device including a controller in operative communication with a microphone, a display, and wireless communications circuitry;
wherein each device is operative to perform the following functions:
(a) recognize a sequence of three numbers spoken into the microphone by a pickleball server,
(b) wirelessly transmit the sequence to the other players, and
(c) indicate the sequence of three numbers on the display of each respective device, with the first number corresponding to the score of the team serving the ball, the second number corresponding to the score of the team receiving the ball, and the third number being a “1” or a “2” corresponding to the serve number of the team serving the ball.

14. The apparatus of claim 13, wherein the third number is displayed on each device as an indicator light or as a numerical digit.

15. The apparatus of claim 13, wherein:
each device includes a pushbutton or other user control; and
the controller in each device is operative to recognize the sequence of three numbers as a voice command or upon activation of the user control.

16. The apparatus of claim 13, wherein the devices are provided in a paired condition or user pairable such that the devices only communicate with each other.

17. The apparatus of claim 13, further including a sideline unit operative to wirelessly receive and display the scores of two teams.
